(19) United States
(12) Patent Application Publication
(10) Pub. No.: US 2006/0098001 A1
(43) Pub. Date: May 11, 2006

(54) System and method for effectively preventing image tearing artifacts in displayed image data

(76) Inventor: Jimmy Kwok Lap Lai, Vancouver (CA)

Correspondence Address: EPSON RESEARCH AND DEVELOPMENT INC;INTELLECTUAL PROPERTY DEPT, 150 RIVER OAKS PARKWAY, SUITE 225, SAN JOSE, CA, 95134, US

(21) Appl. No.: 10/973,369

(22) Filed: Oct. 26, 2004

(51) Int. Cl. G09G 5/00

(52) U.S. Cl. 345/204

(57) ABSTRACT

A system and method for effectively preventing image tearing artifacts in displayed image data includes an input module that writes the image data into a display buffer at an input frame rate, and an output module that reads the image data from the display buffer at an output frame rate that is slower than the input frame rate. At an overwrite point in the display buffer, an anti-tearing module instructs the input module to enter an input-data skipping mode during which the input module halts writing new image data into the display buffer. The input-data skipping mode therefore allows the output module to complete reading a current frame of the image data from the display buffer before the input module overwrites the current frame with a subsequent frame of the image data.

### BACKGROUND SECTION

1. Field of Invention

This invention relates generally to electronic display controller systems, and relates more particularly to a system and method for effectively preventing image tearing artifacts in displayed image data.

2. Description of the Background Art

Implementing efficient methods for displaying electronic image data is a significant consideration for designers and manufacturers of contemporary electronic devices. However, efficiently displaying image data with electronic devices may create substantial challenges for system designers. For example, enhanced demands for increased device functionality and performance may require more system operating power and require additional hardware resources. An increase in power or hardware requirements may also result in a corresponding detrimental economic impact due to increased production costs and operational inefficiencies.

Furthermore, enhanced device capability to perform various advanced display control operations may provide additional benefits to a system user, but may also place increased demands on the control and management of various device components. For example, an enhanced electronic device that efficiently manipulates, transfers, and displays digital image data may benefit from an efficient implementation because of the large amount and complexity of the digital data involved.

Due to growing demands on system resources and substantially increasing data magnitudes, it is apparent that developing new techniques for controlling the display of electronic image data is a matter of concern for related electronic technologies. Therefore, for all the foregoing reasons, developing efficient systems for displaying electronic image data remains a significant consideration for designers, manufacturers, and users of contemporary electronic devices.

### SUMMARY

In accordance with the present invention, a system and method are disclosed for effectively preventing image tearing artifacts in displayed image data. In certain embodiments, an electronic device may be implemented to include a central-processing unit (CPU), a display, and a display controller. In one embodiment, the display controller begins an anti-tearing procedure by performing an initialization that sets a current write address to zero for writing input data to a display buffer. During the foregoing initialization procedure, the display controller also sets a skip value to zero to disable an input-data skipping mode.

An input module may then receive input data from any appropriate data source. The display controller determines whether the foregoing skip value is equal to 1 (input-data skipping mode enabled). If the skip value is not equal to 1, then the display controller may utilize an anti-tearing module to determine whether an overwrite point has been reached in the display buffer. The anti-tearing module may detect the foregoing overwrite point by determining that a current write address for the display buffer is equal to a current read address for the display buffer. The anti-tearing module may also determine whether the current read address is equal to zero.

If the current write address is not equal to the current read address, then the input module writes the input data into the display buffer at the current write address. The input module may then increment the current write address to generate a new current write address. The input module may also determine whether the last pixel of the current frame has been written to display buffer. If the current frame has additional pixels remaining to be written to the display buffer, then the process may return to receive and handle additional input data, as discussed above.

In accordance with the present invention, if the anti-tearing module determines that the current write address for the display buffer is equal to the current read address for the display buffer, and if the current read address is not equal to zero, then the anti-tearing module may set the skip value equal to 1 to thereby enable the input-data skipping mode. The input module may then temporarily suspend writing new input data into the display buffer. As long as the skip value is equal to 1, the display controller may sequentially increment the current write address until no unprocessed pixels from the current frame remain. The display controller may then perform the foregoing initialization procedure and may begin to write a new frame of input data into the display buffer, as discussed above.

The display controller therefore advantageously utilizes the input-data skipping mode to temporarily suspend writing new input data into the display buffer, so that the output module can complete reading the input data from a current frame of input data. Once the output module successfully completes reading all the input data from the current frame of input, then the display controller may re-initialize the anti-tearing procedure and repeat the foregoing sequence. For at least the foregoing reasons, the present invention therefore provides an improved system and method for effectively preventing image tearing artifacts in displayed image data.

### BRIEF DESCRIPTION OF THE DRAWINGS

FIG. 1 is a block diagram for one embodiment of an electronic device, in accordance with the present invention;

FIG. 2 is a block diagram for one embodiment of the display controller of FIG. 1, in accordance with the present invention;

FIG. 3 is a block diagram for one embodiment of the video memory of FIG. 2, in accordance with the present invention;

FIG. 4 is a block diagram for one embodiment of the controller registers of FIG. 2, in accordance with the present invention;

FIG. 5 is a block diagram for one embodiment of the display of FIG. 1, in accordance with the present invention;

FIGS. 6A and 6B are drawings illustrating a data overwriting procedure in the display buffer of FIG. 3.

FIGS. 7A and 7B are drawings illustrating an input-data skipping technique for the display buffer of FIG. 3, in accordance with the present invention;

FIG. 8 is a block diagram illustrating one embodiment for performing an anti-tearing procedure, in accordance with the present invention; and

FIG. 9 is a flowchart of method steps for performing an anti-tearing procedure, in accordance with one embodiment of the present invention.

### DETAILED DESCRIPTION

The present invention relates to an improvement in display controller systems. The following description is presented to enable one of ordinary skill in the art to make and use the invention, and is provided in the context of a patent application and its requirements. Various modifications to the embodiments disclosed herein will be apparent to those skilled in the art, and the generic principles herein may be applied to other embodiments. Thus, the present invention is not intended to be limited to the embodiments shown, but is to be accorded the widest scope consistent with the principles and features described herein.

The present invention comprises a system and method for effectively preventing image tearing artifacts in displayed image data, and includes an input module that writes the image data into a display buffer at an input frame rate. An output module then reads the image data from the display buffer at an output frame rate that is slower than the input frame rate. Prior to an overwrite point in the display buffer, an anti-tearing module advantageously instructs the input module to enter an input-data skipping mode during which the input module halts writing the image data into the display buffer. The input-data skipping mode therefore allows the output module to complete reading a current frame of the image data from the display buffer before the input module overwrites the current frame with a subsequent frame of the image data.

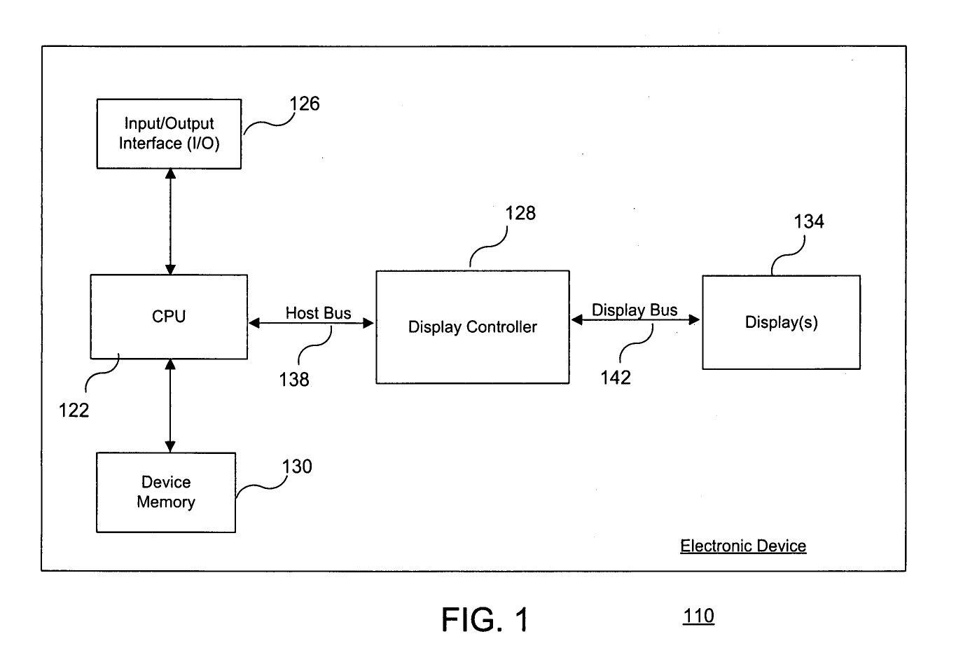

Referring now to FIG. 1, a block diagram for one embodiment of an electronic device 110 is shown, according to the present invention. The FIG. 1 embodiment includes, but is not limited to, a central processing unit (CPU) 122, an input/output interface (I/O) 126, a display controller 128, a device memory 130, and one or more display(s) 134. In alternate embodiments, electronic device 110 may include elements or functionalities in addition to, or instead of, certain of the elements or functionalities discussed in conjunction with the FIG. 1 embodiment.

In the FIG. 1 embodiment, CPU 122 may be implemented as any appropriate and effective processor device or microprocessor to thereby control and coordinate the operation of electronic device 110 in response to various software program instructions. In the FIG. 1 embodiment, device memory 130 may comprise any desired storage-device configurations, including, but not limited to, random access memory (RAM), read-only memory (ROM), and storage devices such as removable memory or hard disk drives. In the FIG. 1 embodiment, device memory 130 may include, but is not limited to, a device application of program instructions that are executed by CPU 122 to perform various functions and operations for electronic device 110. The particular nature and functionality of the device application typically varies depending upon factors such as the type and specific use of the corresponding electronic device 110.

In the FIG. 1 embodiment, the foregoing device application may include program instructions for allowing CPU 122 to provide image data and corresponding transfer and display information via host bus 138 to display controller 128. In accordance with the present invention, display controller 128 then responsively provides the received image data via display bus 142 to at least one of the display(s) 134 of electronic device 110. In the FIG. 1 embodiment, input/output interface (I/O) 126 may include one or more interfaces to receive and/or transmit any required types of information to or from electronic device 110. Input/output interface 126 may include one or more means for allowing a device user to communicate with electronic device 110. In addition, various external electronic devices may communicate with electronic device 110 through I/O 126. For example, a digital imaging device, such as a digital camera, may utilize input/output interface 126 to provide captured image data to electronic device 110.

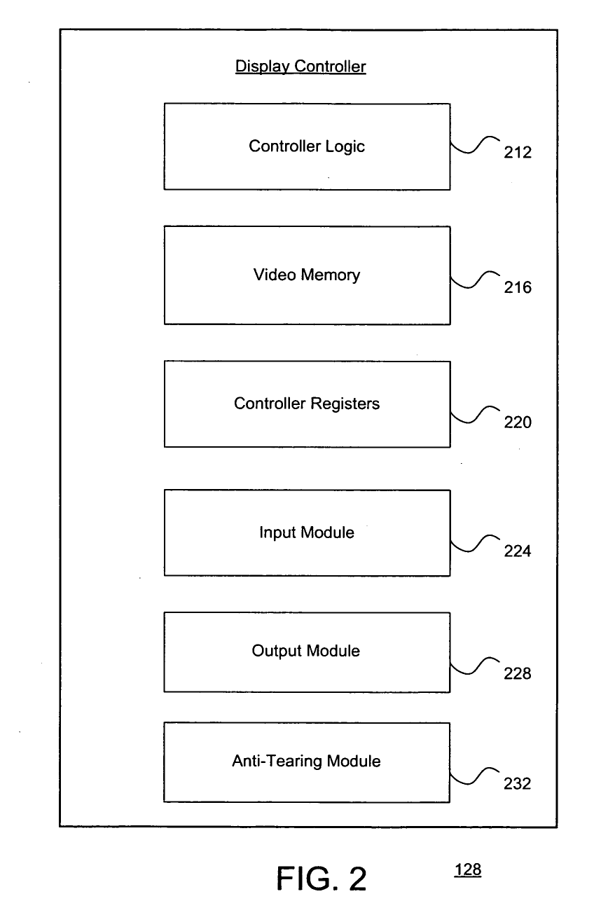

In the FIG. 1 embodiment, electronic device 110 may advantageously utilize display controller 128 for efficiently managing various operations and functionalities relating to display(s) 134. The implementation and functionality of display controller 128 is further discussed below in conjunction with FIGS. 2-4 and 6-9. In the FIG. 1 embodiment, electronic device 110 may be implemented as any desired type of electronic device or system. For example, in certain embodiments, electronic device 110 may alternately be implemented as a cellular telephone, a personal digital assistant device, an electronic imaging device, or a computer device. Various embodiments for the operation and utilization of electronic device 110 are further discussed below in conjunction with FIGS. 2-9.

Referring now to FIG. 2, a block diagram for one embodiment of the FIG. 1 display controller 128 is shown, in accordance with the present invention. The FIG. 2 embodiment includes, but is not limited to, controller logic 212, video memory 216, controller registers 220, an input module 224, an output module 228, and an anti-tearing module 232. In alternate embodiments, display controller 128 may include elements or functionalities in addition to, or instead of, certain of the elements or functionalities discussed in conjunction with the FIG. 2 embodiment.

In the FIG. 2 embodiment, display controller 128 may be implemented as an integrated circuit device that accepts image data and corresponding transfer and display information from CPU 122 (FIG. 1). Display controller 128 then automatically provides the received image data to display 134 of electronic device 110 in an appropriate and efficient manner for displaying to a device user. In the FIG. 2 embodiment, controller logic 212 manages and coordinates the overall operation of display controller 128.

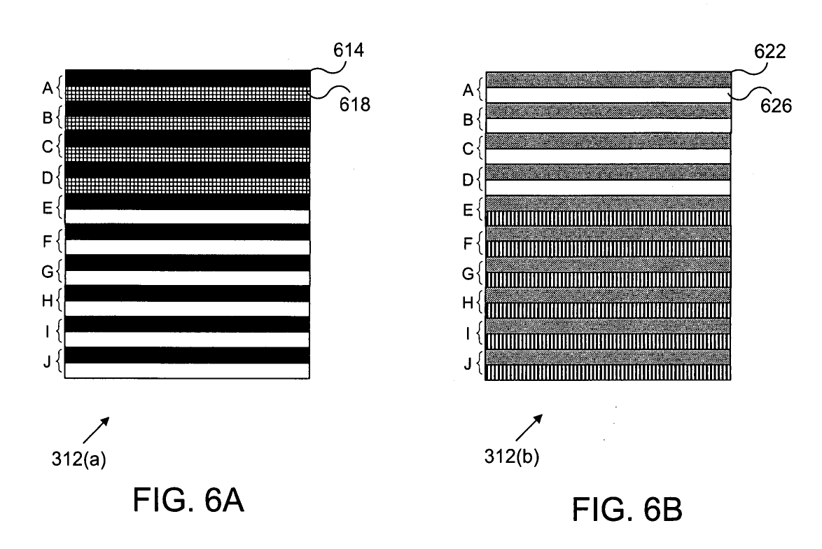

In the FIG. 2 embodiment, display controller 128 may utilize controller registers 220 to store various types of configuration, control and status information. In the FIG. 2 embodiment, display controller 128 may utilize input module 224 to write various types of information and input data into video memory 216 during corresponding write operations. Similarly, display controller 128 may utilize output module 228 to read various types of information and output data from video memory 216 during corresponding read operations. In accordance with the present invention, display controller 128 may utilize anti-tearing module 232 during an anti-tearing procedure that is further discussed below in conjunction with FIGS. 6A, 6B, 7A, 7B, 8, and 9.

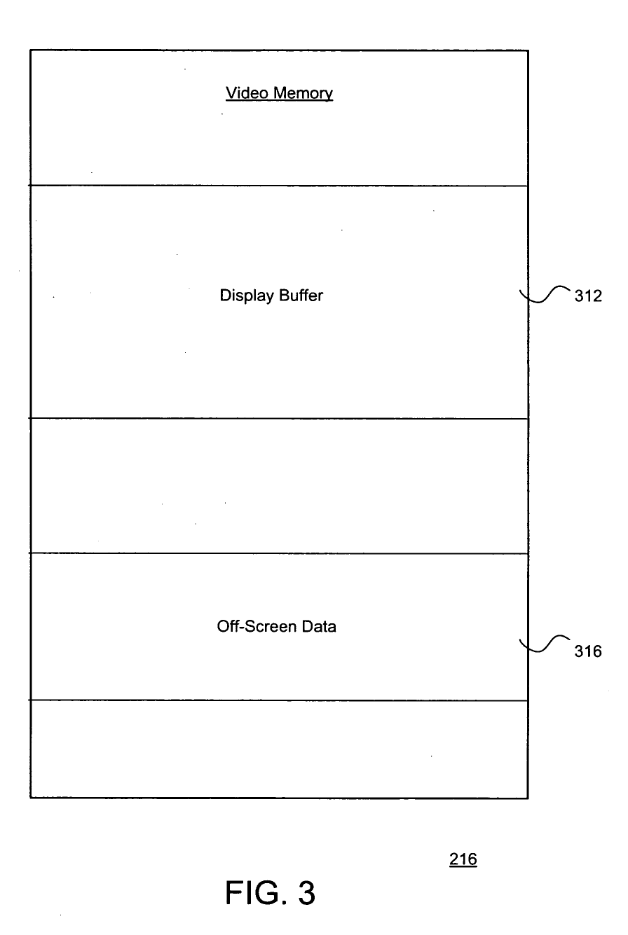

Referring now to FIG. 3, a block diagram for one embodiment of the FIG. 2 video memory 216 is shown, in accordance with the present invention. In the FIG. 3 embodiment, video memory 216 includes, but is not limited to, display buffer 312 and off-screen data 316. In alternate embodiments, video memory 216 may include elements and functionalities in addition to, or instead of, certain of the elements and functionalities discussed in conjunction with the FIG. 3 embodiment.

In the FIG. 3 embodiment, video memory 216 may be implemented by utilizing any effective types of memory devices or configurations. For example, in certain embodiments, video memory 216 may be implemented as a random-access memory (RAM) device. In the FIG. 3 embodiment, CPU 122 (FIG. 1) or another appropriate source writes image data into display buffer 312 for transfer by display controller 128 to display 134 of electronic device 110 for viewing by a device user. In the FIG. 3 embodiment, display buffer 312 may be economically implemented to store only a single frame of image data at a given time. Video memory 216 may therefore store and transfer image data to display 134 without utilizing complex and more costly double-buffering schemes.

In the FIG. 3 embodiment, display buffer 312 stores any appropriate type of information for display upon a screen of display 134 (FIG. 1). For example, display buffer 312 may include main image data corresponding to a main window area on display 134. In addition, display buffer 312 may include picture-in-picture (PIP) image data corresponding to one or more picture-in-picture window areas that are positioned within the foregoing main window area on display 134.

In the FIG. 3 embodiment, off-screen data 316 may include any appropriate type of information or data that is not intended for presentation upon display 134 of electronic device 110. For example, off-screen data 316 may be utilized to cache certain fonts or other objects for use by display controller 128. The utilization of display buffer 312 is further discussed below in conjunction with FIGS. 6A, 6B, 7A, 7B, 8, and 9.

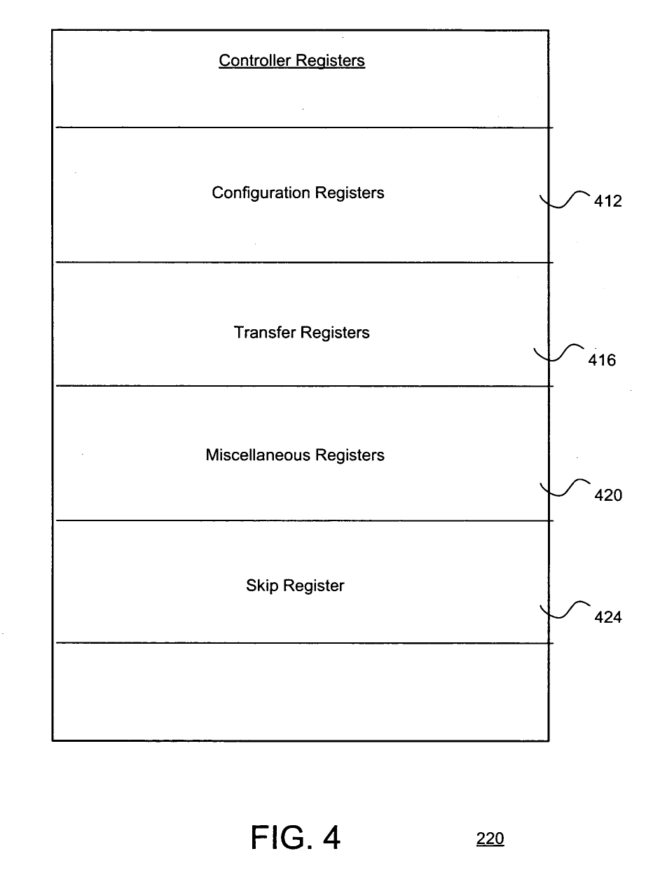

Referring now to FIG. 4, a block diagram for one embodiment of the FIG. 2 controller registers 220 is shown, in accordance with the present invention. In the FIG. 4 embodiment, controller registers 220 include, but are not limited to, configuration registers 412, transfer registers 416, miscellaneous registers 420, and a skip register 424. In alternate embodiments, controller registers 220 may include elements and functionalities in addition to, or instead of, certain of the elements and functionalities discussed in conjunction with the FIG. 4 embodiment.

In the FIG. 4 embodiment, CPU 122 (FIG. 1) or other appropriate entities may advantageously write information into controller registers 220 to specify various types of operational parameters and other relevant information for use by configuration logic 212 of display controller 128. In the FIG. 4 embodiment, controller registers 220 may utilize configuration registers 412 for storing various types of information relating to the configuration of display controller 128 and/or display 134 of electronic device 110. For example, configuration registers 220 may specify a display type, a display size, a display frame rate, and various display timing parameters. In the FIG. 4 embodiment, controller registers 220 may utilize transfer registers 416 for storing various types of information relating to transfer operations for providing pixel data from video memory 216 (FIG. 3) to display 134 of electronic device 110.

In the FIG. 4 embodiment, controller registers 220 may utilize miscellaneous registers 420 for effectively storing any desired type of information or data for use by display controller 128. In the FIG. 4 embodiment, display controller 128 may set a skip value in skip register 424 to enable or disable an input-data skipping mode, in accordance with the present invention. The foregoing input-data skipping mode is further discussed below in conjunction with FIGS. 6A, 6B, 7A, 7B, 8, and 9.

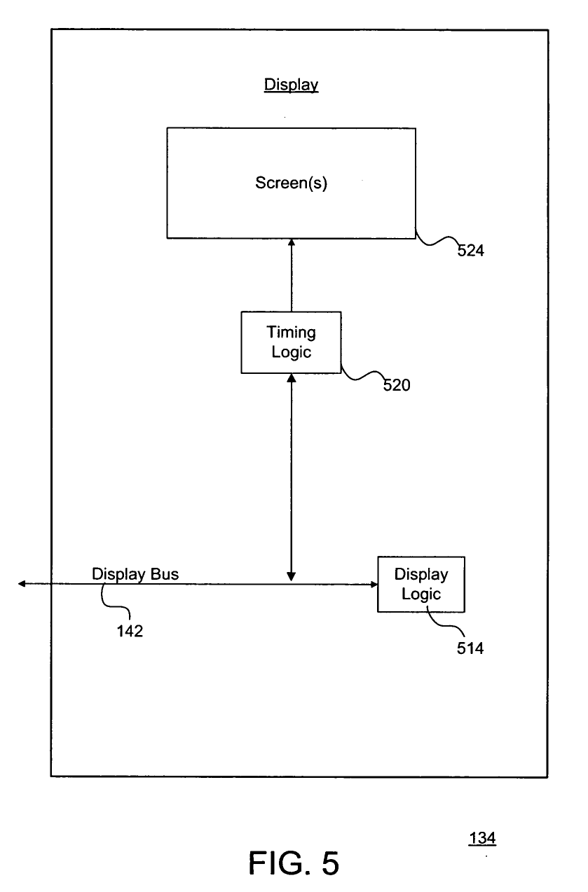

Referring now to FIG. 5, a block diagram for one embodiment of the FIG. 1 display 134 is shown, in accordance with the present invention. In the FIG. 5 embodiment, display 134 includes, but is not limited to, a display memory 512, display logic 514, display registers 516, timing logic 520, and one or more screen(s) 524. In alternate embodiments, display 134 may include elements and functionalities in addition to, or instead of, certain of the elements and functionalities discussed in conjunction with the FIG. 5 embodiment.

In the FIG. 5 embodiment, display logic 514 manages and coordinates data transfer and display functions for display 134. In the FIG. 5 embodiment, display controller 128 provides image data from display buffer 312 (FIG. 3) to display 134 via display bus 142. In the FIG. 5 embodiment, display logic 514 then advantageously provides the image data received from display controller 128 to one or more screens 524 via timing logic 520 for viewing by a device user of electronic device 10.

Referring now to FIGS. 6A and 6B, drawings illustrating a data overwriting procedure in the FIG. 3 display buffer 312 are shown. In the FIG. 6A and FIG. 6B drawings, for purposes of illustration, display buffer 312 is shown having a capacity for storing a single frame of image data comprising ten consecutive lines that are labeled with letters A through J. In alternate embodiments, display buffer 312 typically stores an individual frame of image data that includes a greater number of consecutive lines.

In the FIG. 6A and FIG. 6B drawings, each line A-J stored in display buffer 312 has a top segment that corresponds to a write operation performed by input module 224 (FIG. 2) for storing input data into display buffer 312. For example, line A of the FIG. 6A drawing has a top segment 614, and line A of FIG. 6B has a top segment 622. Similarly, in the FIG. 6A and FIG. 6B embodiments, each line A-J stored in display buffer 312 has a bottom segment that corresponds to a read operation performed by output module 228 (FIG. 2) to read output data from display buffer 312 for transmitting to display 134 (FIG. 1). For example, line A of the FIG. 6A drawing includes a bottom segment 618 and line A of FIG. 6B has a bottom segment 626.

In certain embodiments, an input/output frame rate mismatch may exist in which input module 224 writes frames of image data into display buffer 312 at an input-data writing rate that is higher that an output-data reading rate with which output module 228 reads the frames of image data out of display buffer 312. This input/output frame rate mismatch may produce image tearing artifacts in the image data displayed upon display 134.

In the example shown in FIGS. 6A and 6B, an input/output frame rate mismatch of approximately 5:2 is shown, in which the input module 224 writes five frames of input data into display buffer 312 per every two frames of output data read by output module 228. In alternate embodiments, any desired input/output frame rate mismatch is contemplated. In the FIG. 6A drawing, input module 224 has written all ten lines A-J of input frame 1 (shown in black) into display buffer 312(a). However, because of the input/output frame rate mismatch, output module 228 has only read the first four lines A-D of input frame 1 (shown with a check pattern).

In the FIG. 6B drawing, input module 224 writes all ten lines A-J of input frame 2 (shown in grey) into display buffer 312(b). Output module 228 simultaneously continues, without pause from line D of FIG. 6A, to read output data from display buffer 312(b). However, before output module 228 can complete reading all the input data from frame 1 (shown in FIG. 6A), input module 224 (in FIG. 6B) overwrites the unread image data from frame 1 starting at line E with input image data from input frame 2 (shown with vertical lines).

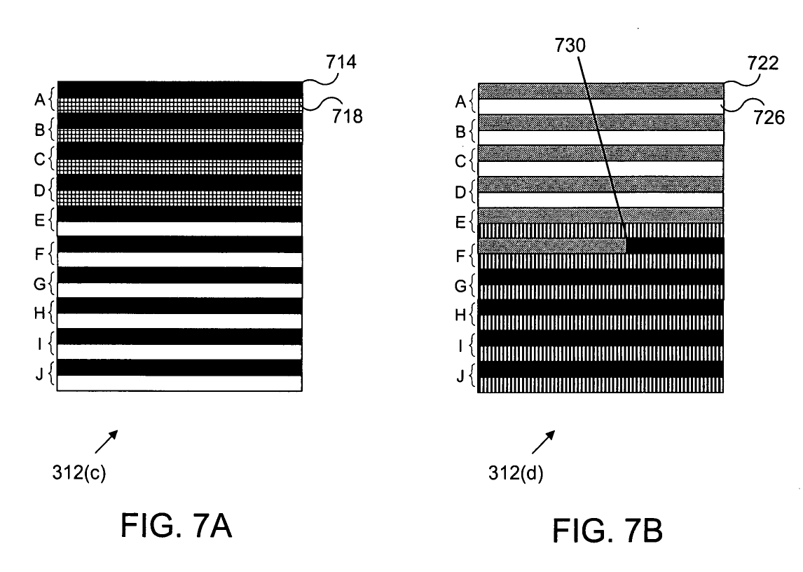

Output module 228 therefore erroneously outputs the overwritten input data from input frame 2 as a second portion of output frame 1 to display 134. When display 134 displays a portion of input frame 1 and a portion of input frame 2 as a single contiguous frame, certain tearing artifacts may be evident on display 134. For example, in cases where motion has occurred between the images shown in input frame 1 and input frame 2, a dividing line or non-continuity between the two sets of image data may be visible as an image tearing artifact. In accordance with the present invention, an anti-tearing procedure to remedy the foregoing overwrite procedure is discussed below in conjunction with FIGS. 7A, 7B, 8, and 9.

Referring now to FIGS. 7A and 7B, drawings illustrating an input-data skipping procedure for the FIG. 3 display buffer 312 are shown. FIGS. 7A and 7B are presented for purposes of illustration, and in alternate embodiments, the present invention may utilize input-data skipping procedures that include configurations and functionalities in addition to, or instead of, certain of the configurations and functionalities discussed in conjunction with FIGS. 7A and 7B. For example, in the FIG. 7A and FIG. 7B drawings, for purposes of illustration, display buffer 312 is shown having a capacity for storing a single frame of image data comprising ten consecutive lines that are labeled with letters A through J. In alternate embodiments, display buffer 312 typically stores an individual frame of image data that includes a greater number of consecutive lines.

In the FIG. 7A and FIG. 7B drawings, each line A-J stored in display buffer 312 has a top segment that corresponds to a write operation performed by input module 224 (FIG. 2) for storing input data into display buffer 312. For example, line A of the FIG. 7A drawing has a top segment 714, and line A of FIG. 6B has a top segment 722. Similarly, in the FIG. 7A and FIG. 7B embodiments, each line A-J stored in display buffer 312 has a bottom segment that corresponds to a read operation performed by output module 228 (FIG. 2) to read output data from display buffer 312 for transmitting to display 134 (FIG. 1). For example, line A of the FIG. 7A drawing includes a bottom segment 718, and line A of FIG. 7B has a bottom segment 726.

As discussed above, in certain embodiments, an input/output frame rate mismatch may exist in which input module 224 writes frames of image data into display buffer 312 at an input-data writing rate that is higher that an output-data reading rate with which output module 228 reads the frames of image data out of display buffer 312. This input/output frame rate mismatch may produce image tearing artifacts in the image data displayed upon display 134, as discussed above in conjunction with FIGS. 6A and 6B.

In the example shown in FIGS. 7A and 7B, an input/output frame rate mismatch of approximately 5:2 is shown, in which the input module 224 writes five frames of input data into display buffer 312 for every two frames of output data read by output module 228. In alternate embodiments, any desired input/output frame rate mismatch is contemplated. In the FIG. 7A drawing, input module 224 has written all ten lines A-J of input frame 1 (shown in black) into display buffer 312(c). However, because of the input/output frame rate mismatch, output module 228 has only read the first four lines A-D of input frame 1 (shown with a check pattern).

In the FIG. 7B drawing, input module 224 begins to write lines of input frame 2 (shown in grey) into display buffer 312(d). Output module 228 simultaneously continues, without pause from line D of FIG. 7A, to read output data from display buffer 312(d) starting at line E (shown with vertical lines). However, before output module 228 can complete reading all the input data from frame 1, an overwrite point 730 is reached in line F at which input module 224 will begin to overwrite the unread image data from frame 1.

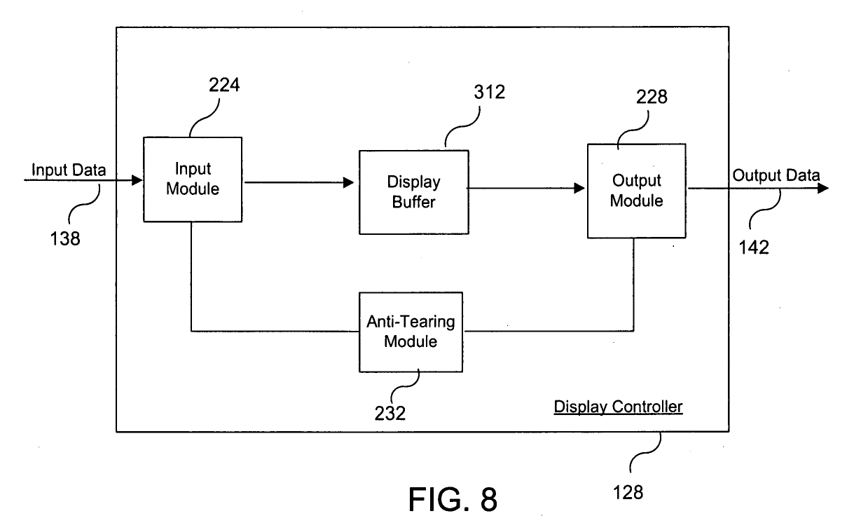

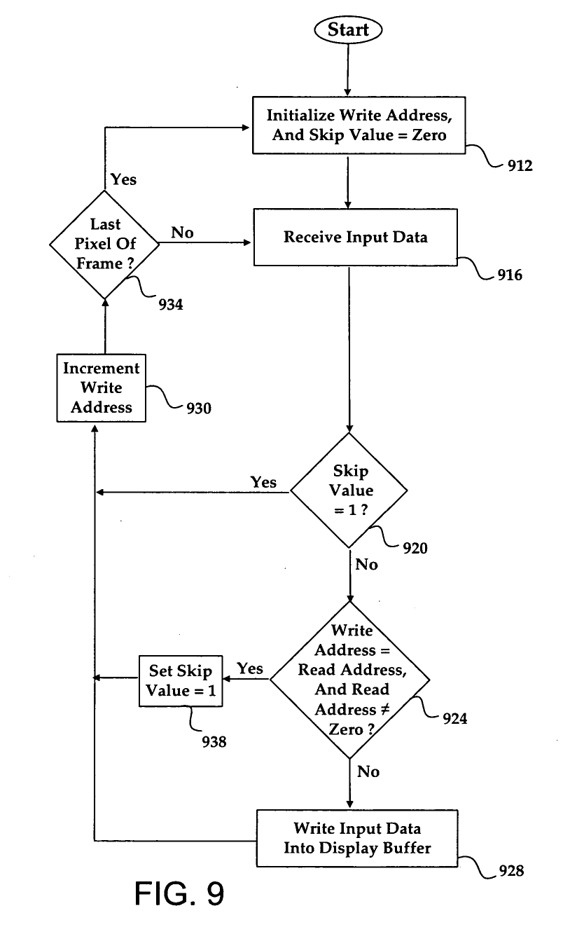

In accordance with the present invention, as shown in the FIG. 7B drawing, at overwrite point 730, display controller 128 advantageously utilizes an input-data skipping technique during which input module 224 enters an input-data skipping mode that halts writing input data from input frame 2, so that output module 228 can complete reading input data from input frame 1 (shown in black) from a second portion of line F and remaining lines G-J. Once output module 228 successfully completes reading all the input data from input frame 1, then display controller 128 may re-initialize the anti-tearing procedure and repeat the foregoing sequence shown in FIGS. 7A and 7B. Further techniques for implementing the anti-tearing procedure are discussed below in conjunction with FIGS. 8 and 9.

Referring now to FIG. 8, a block diagram illustrating one embodiment for performing an anti-tearing procedure is shown, in accordance with the present invention. In alternate embodiments, the present invention may perform anti-tearing procedures that include elements and functionalities in addition to, or instead of, certain of the elements and functionalities discussed in conjunction with the FIG. 8 embodiment.

In the FIG. 8 embodiment, input module 224 performs write operations to write input data into display buffer 312, as discussed above in conjunction with FIGS. 7A and 7B. Similarly, output module 228 performs read operations to read output data from display buffer 312, as discussed above in conjunction with FIGS. 7A and 7B. In the FIG. 8 embodiment, input module 224 includes a write address counter that stores a current write address for the input data being stored into display buffer 312. Output module 228 includes a read address counter that stores a current read address for the output data being accessed from display buffer 312.

In the FIG. 8 embodiment, display controller 128 may utilize anti-tearing module 232 to compare the current write addresses and current read addresses for display buffer 312. When the current read address equals the current write address, overwrite point 730 (see FIG. 7B) has been reached, and anti-tearing module 312 may set a skip value to enable the input-data skipping mode during which input module 224 temporarily stops writing new input data into display buffer 312 until output module 228 completes reading the current frame of input data. In the FIG. 8 embodiment, the anti-tearing procedure may then be re-initialized and may repeat to continue preventing image tearing artifacts on display 134.

Referring now to FIG. 9, a flowchart of method steps for performing an anti-tearing procedure is shown, in accordance with one embodiment of the present invention. The FIG. 9 flowchart is presented for purposes of illustration, and in alternate embodiments, the present invention may utilize steps and sequences in addition to, or instead of, certain of the steps and sequences discussed in conjunction with the FIG. 9 embodiment.

In the FIG. 9 embodiment, in step 912, display controller 128 begins the anti-tearing procedure by performing an initialization procedure that sets a current write address to zero for writing input data to a display buffer 312. During the foregoing initialization procedure, display controller 128 also sets a skip value to zero to disable an input-data skipping mode. In step 916, an input module 224 then receives input data from any appropriate input data source.

In step 920, display controller 128 determines whether the foregoing skip value is equal to 1 (input-data skipping mode enabled). If the skip value is not equal to 1, then in step 924, display controller 128 may utilize an anti-tearing module 232 to determine whether a current write address for display buffer 312 is equal to a current read address for display buffer 312. In step 924, anti-tearing module 232 may also determine whether the current read address is equal to zero.

If the current write address is not equal to the current read address, then in step 928, input module 224 writes the input data into display buffer 312 at the current write address. In step 930, input module 224 may then increment the current write address to generate a new current write address. In step 934, input module 224 may determine whether the last pixel of the current frame has been written to display buffer 312. If the current frame has additional pixels remaining to be written to display buffer 312, then the FIG. 9 process may return to step 916 to receive and handle additional input data, as discussed above.

In accordance with the present invention, in foregoing step 924, if the current write address for display buffer 312 is equal to the current read address for display buffer 312, and if the current read address is not equal to zero, then in step 938, display controller 128 may set the skip value equal to 1, to thereby enable the input-data skipping mode and temporarily halt writing new input data into display buffer 312. In step 920, if the skip value is equal to 1, then the FIG. 9 process may increment the current write address in step 930 until no pixels from the current frame remain (step 934). Then, in step 912, display controller 128 may perform the foregoing initialization procedure, and may repeat the anti-tearing procedure discussed above. For at least the foregoing reasons, the present invention therefore provides an improved system and method for effectively preventing image tearing artifacts in displayed image data.

The invention has been explained above with reference to certain preferred embodiments. Other embodiments will be apparent to those skilled in the art in light of this disclosure. For example, the present invention may be implemented using certain configurations and techniques other than those described in the embodiments above. Additionally, the present invention may effectively be used in conjunction with systems other than those described above as the preferred embodiments. Therefore, these and other variations upon the foregoing embodiments are intended to be covered by the present invention, which is limited only by the appended claims.

What is claimed is:

1. A system for handling image data, comprising:
an input module that writes said image data into a display buffer at an input frame rate;
an output module that reads said image data from said display buffer at an output frame rate that is slower than said input frame rate; and
an anti-tearing module that instructs said input module to enter an input-data skipping mode during which said input module halts writing said image data into said display buffer, said input-data skipping mode allowing said output module to complete reading a current frame of said image data from said display buffer before said input module overwrites said current frame with a subsequent frame of said image data.

2. The system of claim 1 wherein an input/output frame rate mismatch results from said input frame rate being faster than said output frame rate, said input-data skipping mode preventing image-tearing artifacts in said image data when said current frame is displayed upon a display device.

3. The system of claim 1 wherein said display buffer is implemented with a single-frame storage capacity for consecutively storing only single frames of said image data.

4. The system of claim 1 wherein a re-initialization procedure is performed after said input module completes receiveing said current frame of said image data, said re-initialization procedure disabling said input-data skipping mode.

5. The system of claim 1 wherein said output module provides said image data to a data destination that includes a display for a portable electronic device.

6. The system of claim 5 wherein said portable electronic device is implemented as a portable cellular telephone device.

7. The system of claim 1 wherein said input module, said output module, and said anti-tearing module are implemented in a display controller that coordinates providing said image data to a display device, said display controller being implemented as an integrated circuit device.

8. The system of claim 1 wherein said anti-tearing module utilizes a comparator device to compare a write address from a write address counter and a read address from a read address counter to determine when to enter said input-data skipping mode.

9. The system of claim 1 wherein said anti-tearing module instructs said input module to enter said input-data skipping mode prior to an overwrite point in said display buffer, said overwrite point occurring where an input write address for said image data is equal to an output read address for said image data.

10. The system of claim 1 wherein said anti-tearing module programs a skip value in a skip register to selectively enable and disable said input-data skipping mode.

11. The system of claim 1 wherein a display controller performs an initialization procedure for utilizing said display buffer, said initialization procedure setting a write address counter to a value of zero for initially writing said image data to said display buffer.

12. The system of claim 1 wherein a display controller performs an initialization procedure for utilizing said display buffer, said initialization procedure setting a skip value to a value of zero to disable said input-data skipping mode.

13. The system of claim 1 wherein said input module receives said image data from a data source, said input module writing said image data into said display buffer at a current write address if said input-data skipping mode is not enabled, said input module then incrementing said current write address to produce an incremented write address for continuing to write said image data into said display buffer.

14. The system of claim 1 wherein said input module receives said image data from a data source, said input module discarding said image data while said input-data skipping mode is enabled, said input module resuming to write said image data into said display buffer after said output module completes reading said current frame and a re-initialization procedure is performed to disable said input-data skipping mode.

15. The system of claim 1 wherein said anti-tearing module instructs said input module to enter said input-data skipping mode only when a write address for said display buffer equals a read address for said display buffer.

16. The system of claim 15 wherein said anti-tearing module additionally requires that said read address not be equal to zero before instructing said input module to enter said input-data skipping mode.

17. The system of claim 1 wherein a display controller determines when a final pixel of said current frame has been received by said input module, said display controller responsively coordinating a re-initialization procedure to disable said input-data skipping mode, and to reset a write address to zero for said input module to resume writing said image data into said display buffer.

18. The system of claim 1 wherein said output module provides said current frame to a display device in a contiguous frame format due to the input-data skipping mode to thereby avoid tearing artifacts when said image data is displayed on said display device.

19. The system of claim 1 wherein said input-data skipping mode causes said input module to drop intervening image data until said output module completes reading said current frame from said display buffer in an uninterrupted form for display upon a display device.

20. The system of claim 1 wherein said display buffer is implemented in a simplified single-frame capacity configuration that economically conserves memory resources by avoiding more complex memory architectures and double-buffering techniques.

21. A method for handling image data, comprising the steps of:
writing said image data with an input module into a display buffer at an input frame rate;
utilizing an output module to read said image data from said display buffer at an output frame rate that is slower than said input frame rate; and
instructing said input module with an anti-tearing module to enter an input-data skipping mode during which said input module halts writing said image data into said display buffer, said input-data skipping mode allowing said output module to complete reading a current frame of said image data from said display buffer before said input module overwrites said current frame with a subsequent frame of said image data.

22. The method of claim 21 wherein an input/output frame rate mismatch results from said input frame rate being faster than said output frame rate, said input-data skipping mode preventing image-tearing artifacts in said image data when said current frame is displayed upon a display device.

23. The method of claim 21 wherein said display buffer is implemented with a single-frame storage capacity for consecutively storing only single frames of said image data.

24. The method of claim 21 wherein a re-initialization procedure is performed after said input module completes receiving said current frame of said image data, said re-initialization procedure disabling said input-data skipping mode.

25. The method of claim 21 wherein said output module provides said image data to a data destination that includes a display for a portable electronic device.

26. The method of claim 25 wherein said portable electronic device is implemented as a portable cellular telephone device.

27. The method of claim 21 wherein said input module, said output module, and said anti-tearing module are implemented in a display controller that coordinates providing said image data to a display device, said display controller being implemented as an integrated circuit device.

28. The method of claim 21 wherein said anti-tearing module utilizes a comparator device to compare a write address from a write address counter and a read address from a read address counter to determine when to enter said input-data skipping mode.

29. The method of claim 21 wherein said anti-tearing module instructs said input module to enter said input-data skipping mode prior to an overwrite point in said display buffer, said overwrite point occurring where an input write address for said image data is equal to an output read address for said image data.

30. The method of claim 21 wherein said anti-tearing module programs a skip value in a skip register to selectively enable and disable said input-data skipping mode.

31. The method of claim 21 wherein a display controller performs an initialization procedure for utilizing said display buffer, said initialization procedure setting a write address counter to a value of zero for initially writing said image data to said display buffer.

32. The method of claim 21 wherein a display controller performs an initialization procedure for utilizing said display buffer, said initialization procedure setting a skip value to a value of zero to disable said input-data skipping mode.

33. The method of claim 21 wherein said input module receives said image data from a data source, said input module writing said image data into said display buffer at a current write address if said input-data skipping mode is not enabled, said input module then incrementing said current write address to produce an incremented write address for continuing to write said image data into said display buffer.

34. The method of claim 21 wherein said input module receives said image data from a data source, said input module discarding said image data while said input-data skipping mode is enabled, said input module resuming to write said image data into said display buffer after said output module completes reading said current frame and a re-initialization procedure is performed to disable said input-data skipping mode.

35. The method of claim 21 wherein said anti-tearing module instructs said input module to enter said input-data skipping mode only when a write address for said display buffer equals a read address for said display buffer.

36. The method of claim 35 wherein said anti-tearing module additionally requires that said read address not be equal to zero before instructing said input module to enter said input-data skipping mode.

37. The method of claim 21 wherein a display controller determines when a final pixel of said current frame has been received by said input module, said display controller responsively coordinating a re-initialization procedure to disable said input-data skipping mode, and to reset a write address to zero for said input module to resume writing said image data into said display buffer.

38. The method of claim 21 wherein said output module provides said current frame to a display device in a contiguous frame format due to the input-data skipping mode to thereby avoid tearing artifacts when said image data is displayed on said display device.

39. The method of claim 21 wherein said input-data skipping mode causes said input module to drop intervening image data until said output module completes reading said current frame from said display buffer in an uninterrupted form for display upon a display device.

40. The method of claim 21 wherein said display buffer is implemented in a simplified single-frame capacity configuration that economically conserves memory resources by avoiding more complex memory architectures and double-buffering techniques.

41. A system for handling image data, comprising:
means for writing said image data into a display buffer at an input frame rate;
means for reading said image data from said display buffer at an output frame rate that is slower than said input frame rate; and
means for instructing said input module to enter an input-data skipping mode during which said means for writing halts writing said image data into said display buffer, said input-data skipping mode allowing said means for reading to complete reading a current frame of said image data from said display buffer before said means for writing overwrites said current frame with a subsequent frame of said image data.

42. A system for handling image data, comprising:
an input module that writes said image data into a display buffer at an input frame rate;
an output module that reads said image data from said display buffer at an output frame rate that is slower than said input frame rate; and
an anti-tearing module that instructs said input module to enter an input-data skipping mode during which said input module halts writing said image data into said display buffer at an overwrite point in said display buffer.
